(19) United States
(12) Patent Application Publication
(10) Pub. No.: US 2011/0066362 A1
(43) Pub. Date: Mar. 17, 2011

(54) METHOD AND SYSTEM DISPLAYING AIRCRAFT IN-TRAIL TRAFFIC

(75) Inventor: Gang He, Morristown, NJ (US)

(73) Assignee: HONEYWELL INTERNATIONAL INC., Morristown, NJ (US)

(21) Appl. No.: 12/561,792

(22) Filed: Sep. 17, 2009

(51) Int. Cl. G05D 1/00; G06G 7/76

(52) U.S. Cl. 701/120

(57) ABSTRACT

A system and method for displaying in-trail traffic includes providing (402), on a display (200) of a base aircraft (202), a list (222) of identifying numbers of other aircraft (204, 206, 208, 210, 212, 214) transmitting in the ADSB system. One of the other aircraft (206) is selected (404) from the list (222) by the aircrew of the base aircraft (202) for trailing. At least a portion (204, 206, 208, 210) of the other aircraft are displayed (508) as determined (506) from flight information of each aircraft and the route of flight of the in-trail traffic. Flight information of the selected aircraft (206) is presented (512) for comparison with the base aircraft (202).

### TECHNICAL FIELD

The present invention generally relates to aircraft display systems and more particularly to a method of selecting and displaying images of aircraft in-trail.

### BACKGROUND OF THE INVENTION

It is important for pilots to know the position of other aircraft in their airspace that may present a hazard to safe flight. Typical displays that illustrate other aircraft show text to provide important information such as altitude and speed. This text occupies much of the screen when there are several aircraft being displayed, thereby increasing the chance for confusion. Furthermore, the pilot must interpret the information provided in the text occupying her thought processes when she may have many other decisions to make.

With increased availability of Automated Dependent Surveillance Broadcast (ADSB) installations, Cockpit Display of Traffic Information (CDTI) displays can show surrounding traffic with increased accuracy and provide improved situation awareness. In the ADSB system, aircraft transponders receive GPS signals and determine the aircraft's precise position, which is combined with other data and broadcast out to other aircraft and air traffic controllers. This display of surrounding traffic increases the pilot's awareness of traffic over and above that provided by Air Traffic Control. One known application allows approach in-trail procedures and enhanced visual separation and stationery keeping. With the CDTI display, flight crews can find the in-trail target on the display and then follow the target. However, when the number of ADSB targets become numerous, particularly in the vicinity of an airport, indentifying a specific target efficiently on a CDTI display can be time consuming For in-trail targets, pilots are typically given a tail number by ATC, which must often be typed into the CDTI display by the pilot. This procedure allows for errors by the pilot potentially typing in the incorrect number and is time consuming.

Accordingly, it is desirable to provide a system and method of selecting and displaying in-trail air traffic symbology that may be easily managed by the pilot. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A method for displaying in-trail traffic includes providing on a display of a base aircraft a list of identifying numbers of other aircraft transmitting in the ADSB system, selecting one of the other aircraft from the list, displaying at least a portion of the other aircraft based on flight data of each aircraft including an intended route of flight, and presenting flight information of the selected aircraft.

The system for displaying a base aircraft, a target aircraft in which the base aircraft is to follow, and a plurality of other aircraft, comprising a processor configured to process flight information of each of the target aircraft, the base aircraft, and the other aircraft; provide a list of identification numbers for each of the target aircraft and the other aircraft; process the identify of the target aircraft as selected by the base aircraft aircrew from the list; determine a format for the display of each of the base aircraft, target aircraft, and the other aircraft based on the processed flight information; and provide a plurality of display commands; and a display for displaying, in response to the display commands, a list of the target aircraft and the other aircraft; a symbol for each of the other aircraft if within a specified range, the base aircraft, and the target aircraft; and flight information of the target aircraft and the base aircraft.

### BRIEF DESCRIPTION OF THE DRAWINGS

The present invention will hereinafter be described in conjunction with the following drawing figures, wherein like numerals denote like elements, and

FIG. 1 is a functional block diagram of a flight display system;

FIG. 2 is a first image displayed in accordance with an exemplary embodiment that may be rendered on the flight display system of FIG. 1;

FIG. 3 is a second image displayed in accordance with the exemplary embodiment that may be rendered on the flight display system of FIG. 1; and

FIG. 4 is a flow chart of the steps of the exemplary embodiment.

### DETAILED DESCRIPTION OF AN EXEMPLARY EMBODIMENT

The following detailed description of the invention is merely exemplary in nature and is not intended to limit the invention or the application and uses of the invention. Furthermore, there is no intention to be bound by any theory presented in the preceding technical field, background, brief summary, or the following detailed description.

A method is disclosed for identifying, selecting, and comparing flight information of an aircraft for which a base aircraft is to follow (typically called in-trail). A list of identification numbers, e.g., tail numbers, is presented for selection by the aircrew of the aircraft in which they are to follow. Algorithms interpret aircraft transmitting aircraft related parameters, for example, Automated Dependent Surveillance Broadcast (ADSB) signals, and identify those within a pertinent airspace. For example, during landing operations, aircraft on the ground or well above approach landing altitude profiles are not related to the in-trail approach operation and may be excluded form the indentified aircraft. Likewise, those aircraft spaced by a significant lateral distance may also be excluded from the indentified aircraft. Flight information of the selected aircraft pertinent to the in-trail procedure is displayed. Pertinent information, for example, may include aircraft type, distance from the current aircraft, and airspeed. Similar information of the base aircraft may also be displayed adjacent the pertinent information for comparison. If the compared information of the two aircraft exceeds a threshold, a visual and/or verbal warning may be given so the aircrew may initiate corrective procedures, such as changing airspeed or disengaging from the in-trail procedures.

A display system presents images of aircraft disposed from a base aircraft on a screen viewable by a pilot. The format of these aircraft change when selected for the in-trail procedure. The format may include, for example, different sizes or colors.

While the exemplary embodiments described herein refer to displaying the information on airborne aircraft, the invention may also be applied to other exemplary embodiments such as displays in sea going vessals and displays used by traffic controllers.

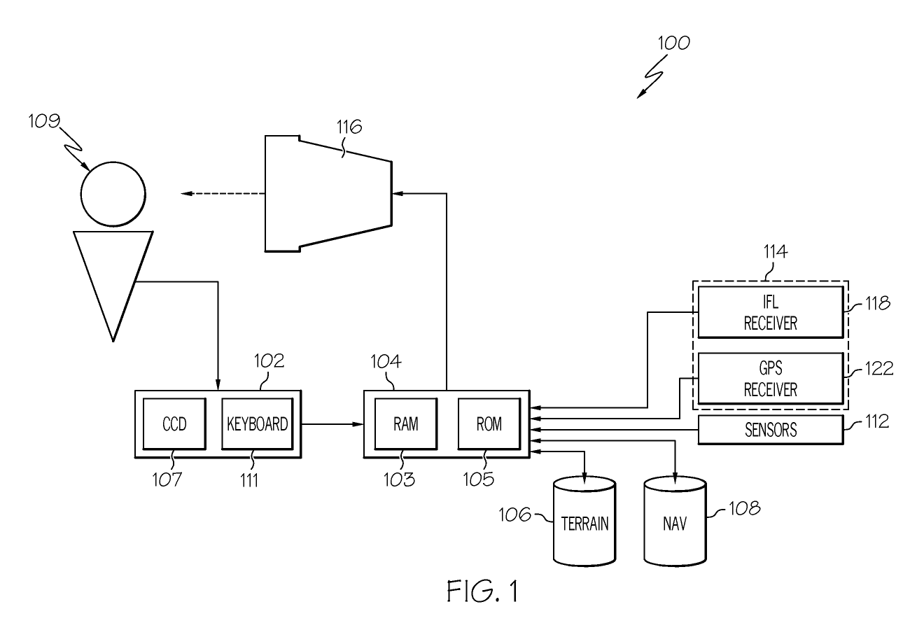

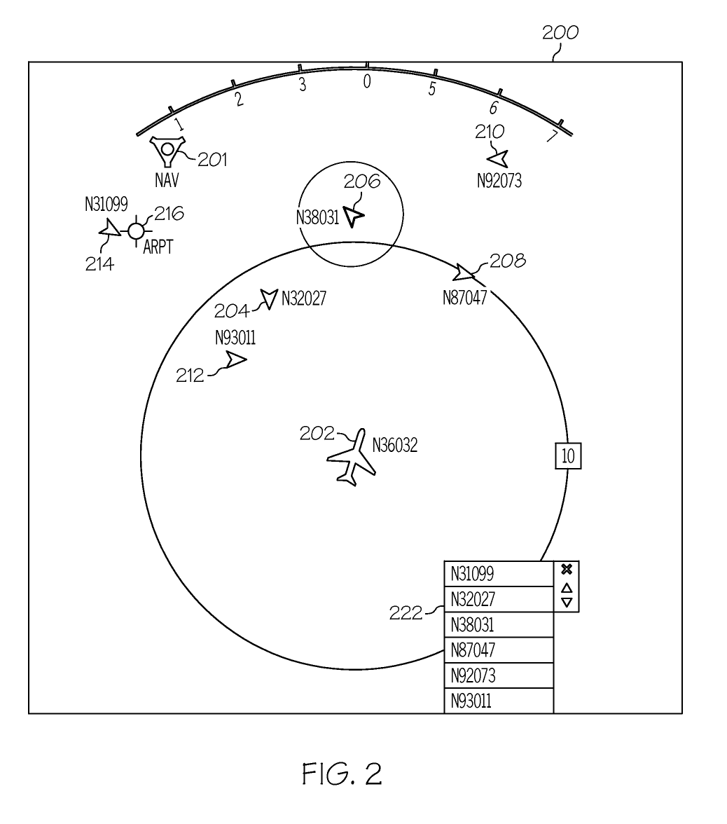

Referring to FIG. 1, an exemplary flight deck display system 100 is depicted and will be described. The system 100 includes a user interface 102, a processor 104, one or more terrain databases 106, one or more navigation databases 108, various sensors 112, various external data sources 114, and a display device 116. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, a cursor control device (CCD) 107, such as a mouse, a trackball, or joystick, and/or a keyboard, one or more buttons, switches, or knobs. In the depicted embodiment, the user interface 102 includes a CCD 107 and a keyboard 111. The user 109 uses the CCD 107 to, among other things, move a cursor symbol on the display screen (see FIG. 2), and may use the keyboard 111 to, among other things, input textual data.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

No matter how the processor 104 is specifically implemented, it is in operable communication with the terrain databases 106, the navigation databases 108, and the display device 116, and is coupled to receive various types of inertial data from the various sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108, and to supply appropriate display commands to the display device 116. The display device 116, in response to the display commands, selectively renders various types of textual, graphic, and/or iconic information. The preferred manner in which the textual, graphic, and/or iconic information are rendered by the display device 116 will be described in more detail further below. Before doing so, however, a brief description of the databases 106, 108, the sensors 112, and the external data sources 114, at least in the depicted embodiment, will be provided.

The terrain databases 106 include various types of data representative of the terrain over which the aircraft is flying, and the navigation databases 108 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the terrain databases 106 and the navigation databases 108 are, for clarity and convenience, shown as being stored separate from the processor 104, all or portions of either or both of these databases 106, 108 could be loaded into the RAM 103, or integrally formed as part of the processor 104, and/or RAM 103, and/or ROM 105. The terrain databases 106 and navigation databases 108 could also be part of a device or system that is physically separate from the system 100.

The sensors 112 may be implemented using various types of inertial sensors, systems, and or subsystems, now known or developed in the future, for supplying various types of inertial data. The inertial data may also vary, but preferably include data representative of the state of the aircraft such as, for example, aircraft speed, heading, altitude, and attitude. The number and type of external data sources 114 may also vary. For example, the external systems (or subsystems) may include, for example, a terrain avoidance and warning system (TAWS), a traffic and collision avoidance system (TCAS), a runway awareness and advisory system (RAAS), a flight director, and a navigation computer, just to name a few. However, for ease of description and illustration, only an instrument landing system (ILS) receiver 118 and a global position system (GPS) receiver 122 are depicted in FIG. 1, and will now be briefly described.

As is generally known, the ILS is a radio navigation system that provides aircraft with horizontal (or localizer) and vertical (or glide slope) guidance just before and during landing and, at certain fixed points, indicates the distance to the reference point of landing on a particular runway. The system includes ground-based transmitters (not illustrated) that transmit radio frequency signals. The ILS receiver 118 receives these signals and, using known techniques, determines the glide slope deviation of the aircraft. As is generally known, the glide slope deviation represents the difference between the desired aircraft glide slope for the particular runway and the actual aircraft glide slope. The ILS receiver 118 in turn supplies data representative of the determined glide slope deviation to the processor 104.

The GPS receiver 122 is a multi-channel receiver, with each channel tuned to receive one or more of the GPS broadcast signals transmitted by the constellation of GPS satellites (not illustrated) orbiting the earth. Each GPS satellite encircles the earth two times each day, and the orbits are arranged so that at least four satellites are always within line of sight from almost anywhere on the earth. The GPS receiver 122, upon receipt of the GPS broadcast signals from at least three, and preferably four, or more of the GPS satellites, determines the distance between the GPS receiver 122 and the GPS satellites and the position of the GPS satellites. Based on these determinations, the GPS receiver 122, using a technique known as trilateration, determines, for example, aircraft position, groundspeed, and ground track angle. These data may be supplied to the processor 104, which may determine aircraft glide slope deviation therefrom. Preferably, however, the GPS receiver 122 is configured to determine, and supply data representative of, aircraft glide slope deviation to the processor 104.

The display device 116, as noted above, in response to display commands supplied from the processor 104, selectively renders various textual, graphic, and/or iconic information, and thereby supply visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 116 may additionally be implemented as a panel mounted display, a HUD (head-up display) projection, or any one of numerous known technologies. It is additionally noted that the display device 116 may be configured as any one of numerous types of aircraft flight deck displays. For example, it may be configured as a multi-function display, a horizontal situation indicator, or a vertical situation indicator, just to name a few. In the depicted embodiment, however, the display device 116 is configured as a primary flight display (PFD).

With reference to FIG. 2, the display 116 includes a display area 200 in which multiple graphical images may be simultaneously displayed. Although a top down view is depicted, it is understood that a vertical, or perspective, view could be depicted in accordance with the exemplary embodiments. The display area 200 may also include navigational aids, such as the station 201 having the identifier NAV, and various map features (not shown) including, but not limited to, terrain, political boundaries, and terminal and special use airspace areas, which, for clarity, are not shown in FIG. 2. A symbol 202 is displayed the base aircraft which contains the flight deck display system 100. Data is processed for the base aircraft and, when received, for the other aircraft 204, 206, 208, 210, 212, 214 transmitting aircraft related parameters, such as within the ADSB system, from a distal source (not shown) such as ground stations or satellites or is transmitted directly from the aircraft 204, 206, 2089, 210, 212, 214. The aircraft displayed may be limited to a predefined area, such as within a specified distance from the flight path (pathway). For this first exemplary embodiment of FIG. 2, the data comprises positional data (location and direction) and altitude. An image of each aircraft 204, 206, 208, 210, 212, 214 is displayed on the display area 200 in a location determined by the positional data. The algorithm prompts the display of the identification numbers, e.g., call signs, N36027, N38031, N87047, N92073, N93011, N31099 for aircraft 204, 206, 208, 210, 212, 214, respectively, as a menu 222 on the display 200.

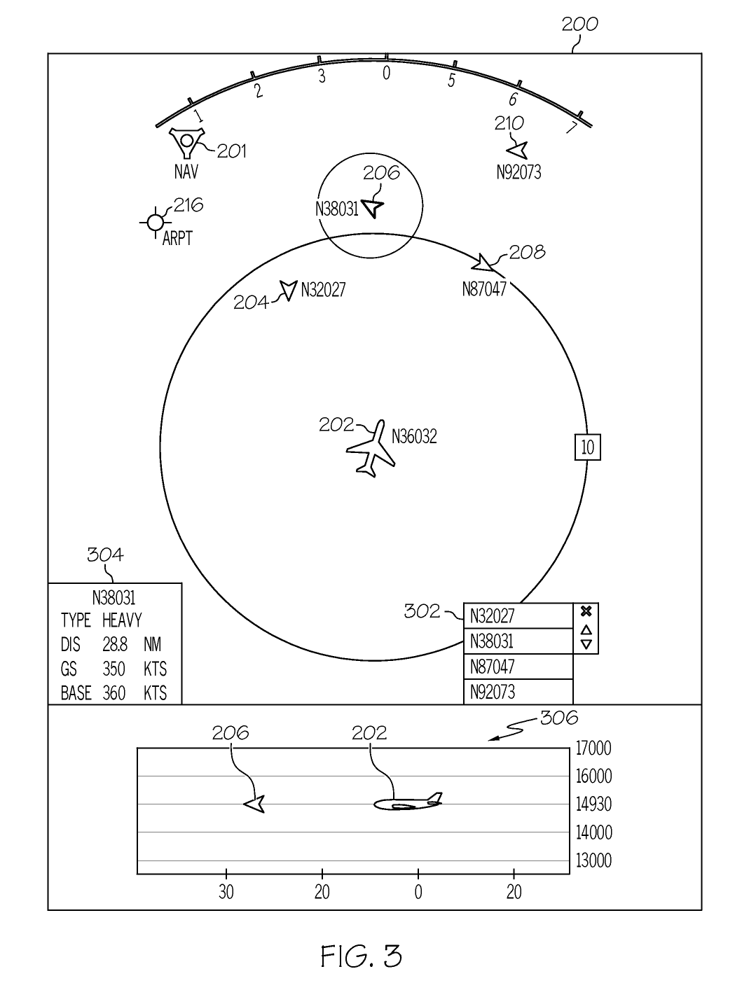

When it is determined, such as instructed by air traffic control, that the base aircraft 202 is to trail a specific aircraft (aircraft 206 having call sign N38031 in this specific example) having a specific flight route defined, the aircrew will select the call sign N38031 from the menu 222. This selection may be accomplished in any one of several methods, such as touching on a touch screen or moving a cursor onto the call sign and selecting in a known manner. If the base aircraft is at 15,000 feet, only aircraft within the altitude range of 10,000 to 20,000, for example, are displayed (FIG. 3). Therefore, the aircraft 212 flying at 25,000 feet and the aircraft 214 sitting on the ground at the airport 216 (having an identification ARPT) would not be displayed. The “target” aircraft 204, 206, 208, 210, having identification numbers, e.g., call signs, N36027, N38031, N87047, N92073, respectively, are also listed in a menu 302 on the display 200. After this selection is made by the aircrew, flight information related to the selected aircraft 206 will appear in a data box 304. The flight information may include, for example, the aircraft's 206 call sign N36031, the type of aircraft, for example, heavy, the distance from the base aircraft 202, and its ground speed. Data relating to flight conditions of the base aircraft 202 may also appear in the menu 302. For example, the ground speed (360 knots as displayed) of the base aircraft 202 may be displayed for an easy comparison by the aircrew with the displayed ground speed (350 knots) of the selected aircraft 206. A comparison may also be made within the algorithm, and if a threshold is exceeded, for example a ground speed difference of 50 knots, a visual or audible warning may be issued to the aircrew.

The format of each displayed aircraft 202, 204, 206, 208, 210 is defined by the algorithm. The format may include different displayed sizes, colors, or images. For example, the base aircraft 202 may be a first color, the selected aircraft 206 may be a second color, while the remaining displayed aircraft 204, 208, 210 may be a third color. The base aircraft 202 may assume a shape different from the other aircraft 204, 206, 208, 210 to reduce confusion by the aircrew.

In one exemplary embodiment, a vertical image 306 is provided illustrating the altitude versus distance separation in graph form of the base aircraft 202 and the target aircraft 206. It is seen that both aircraft 202 and 206 are at about 15,000 feet and are spaced about 28 miles apart.

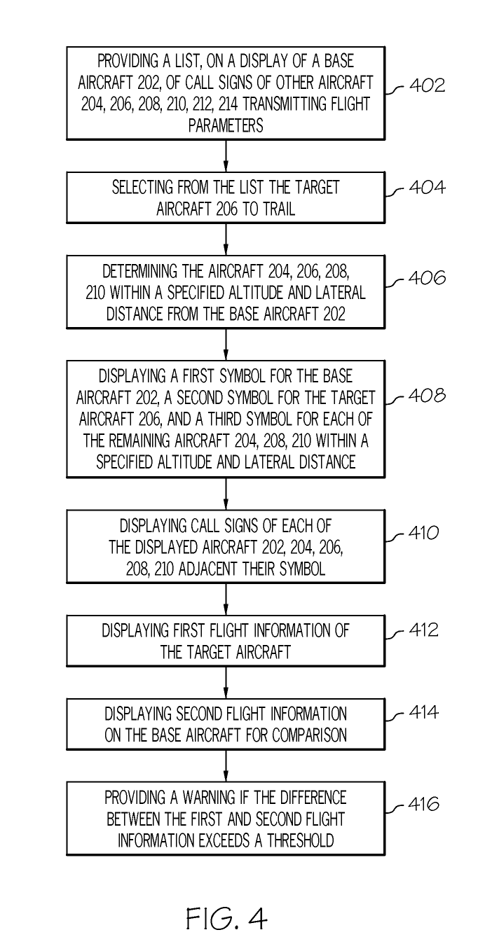

FIG. 4 is a flow chart of the steps in the exemplary method, including providing 402 a list, on the display 200 of the base aircraft 202, of other aircraft 204, 206, 208, 210, 21, 214 transmitting in the ADSB system. When the target aircraft has been identified and is selected 404 from the list, a determination 406 is made of which aircraft are within a specified altitude and lateral distance of the base aircraft 202 and these other aircraft 204, 206, 208, 210 are displayed 408 along with the base aircraft 202. In some instances, only aircrafts within the a swath of the flight plan route determined by the base aircraft FMS system are selected. The call sign of each aircraft is displayed 410 along side of the respective aircraft. The displayed aircraft may be presented 408 in different formats along with their call sign for quicker and more accurate determination by the aircrew. Flight information of the selected aircraft 206 is displayed 412 in a menu 304. Flight information of the base aircraft 202 may also be displayed 414 for comparison by the aircrew 109. An optional verbal or visual warning may be provided 416 if the difference between the first and second flight information exceeds a threshold.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for displaying in-trail traffic, comprising:
providing on a display a base aircraft and a list of identifying numbers of other aircraft transmitting aircraft related parameters;
selecting one of the other aircraft from the list;
displaying at least a portion of the other aircraft based on flight data of each aircraft, and the selected aircraft; and
presenting flight information of the selected aircraft.

2. The method of claim 1 wherein the displaying step comprises processing the altitude of the other aircraft.

3. The method of claim 1 wherein the displaying step comprises processing the lateral distance between the base and other aircraft.

4. The method of claim 1 wherein the displaying step comprises processing the lateral distance between the other aircraft and a flight plan segment of the base aircraft.

5. The method of claim 1 wherein the displaying step includes processing flight data of other aircraft within a predefined area of the currently planned pathway.

6. The method of claim 1 wherein the displaying step comprises processing the type of each of the other aircraft.

7. The method of claim 1 wherein the displaying step comprises displaying the selected aircraft at an edge of a display when it is beyond the distance of the base being displayed.

8. The method of claim 1 wherein the displaying step comprises displaying the selected aircraft at an edge of a display when it is beyond the distance of the base aircraft being displayed.

9. The method of claim 1 wherein the displaying step comprises displaying the other aircraft as a symbol in a first format and the selected aircraft as a second format.

10. The method of claim 8 wherein the displaying step comprises displaying the base aircraft is a first format and the selected aircraft is a second format.

11. A method for displaying in-trail traffic to a base aircraft, comprising:
identifying all aircraft within a specified distance that are transmitting aircraft related parameters;
displaying a list of identifying numbers of aircraft transmitting aircraft related parameters;
selecting one of the aircraft from the list as a target aircraft;
displaying a symbol for each of the base aircraft, the target aircraft, and at least a portion of the other aircraft based on flight data of each aircraft being within a specified range; and
providing flight information of the selected aircraft.

12. The method of claim 11 wherein the displaying a symbol comprising:
displaying the base aircraft in a first format, the target aircraft in a second format, and the other aircraft in a third format.

13. The method of claim 11 wherein the displaying a symbol step comprises:
determining the range by comparing altitudes of the base aircraft and the other aircraft.

14. The method of claim 11 wherein the displaying a symbol step comprises:
determining the range by comparing lateral distance between the base aircraft and each of the other aircraft.

15. The method of claim 11 wherein the displaying a list step comprises:
determining the list by compiling call signs of each aircraft.

16. The method of claim 11 further comprising:
providing flight information of the base aircraft adjacent to the flight information of the target aircraft.

17. A system for displaying a base aircraft, a target aircraft in which the base aircraft is to follow, and a plurality of other aircraft, comprising:
a processor configured to:
process flight information of each of the target aircraft, the base aircraft, and the other aircraft;
provide a list of identification numbers for each of the target aircraft and the other aircraft;
process the identify of the target aircraft as selected by the base aircraft aircrew from the list;
determine a format for the display of each of the base aircraft, target aircraft, and the other aircraft based on the processed flight information; and
provide a plurality of display commands; and
a display for displaying in response to the display commands:
a list of the target aircraft and the other aircraft;
a symbol for each of the other aircraft if within a specified range, the base aircraft, and the target aircraft; and
flight information of the target aircraft and the base aircraft.

18. The system of claim 17 wherein the specified range is based on at least one of altitude and lateral distance from the base aircraft.

19. The system of claim 17 wherein flight information includes altitude, speed, and heading.

20. The system of claim 17 wherein the symbol includes a first symbol for the base aircraft, a second symbol for the target aircraft, and a third symbol for each of the other aircraft.
